(19) United States
(12) Patent Application Publication
(10) Pub. No.: US 2006/0133220 A1
(43) Pub. Date: Jun. 22, 2006

(54) Self-righting device

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/020,781

(22) Filed: Dec. 22, 2004

(51) Int. Cl. G04B 37/00

(52) U.S. Cl. 368/276

(57) ABSTRACT

A self righting device wherein two or more displays on which graphical or numerical information may be displayed. The self righting mechanism incorporates an eccentric weight whereby the viewer may rotate the housing of the device to view the information visible n a second display face and upon release of the housing, the self righting feature causes the housing to reorient such that the original display face which was facing the viewer is once again in its original position. The device may also incorporate antifriction bearings at each of its axial pivot points such that the rotation of the housing with respect to the stand is smooth and easy.

### BACKGROUND OF THE INVENTION

Display devices such as digital clocks have long been known to those skilled in the art. In recent years, however, the advances in electronics and digital technology have facilitated numerous new display mechanisms for use in these types of devices. Some of these devices now permit the viewer to display typical clock functions, such as time, along with other related functions, such as calendar dates. In the present state of the art, however, the user typically must reposition the device to display one function and again reposition the device to display an alternative function display.

What has been lacking in the art is a device which is capable of simultaneously displaying various types of graphical and numerical information, but which permits the viewer to select one display as their favorite and include a mechanism such that the other displays may be viewed by repositioning the device, but when the viewer releases contact with the device, it automatically reorients such that the favorite display position once again becomes the forefront display. Having such a functional aspect would permit the viewer to quickly check one or more alternate displays and not be concerned with reorienting the device to its original position.

### SUMMARY OF THE INVENTION

The present invention meets the need for a multi-function display device which incorporates an self righting mechanism such that a selected face would automatically maintain the front or other selected position on the device. For example, if the device were equipped with numerous clock displays set to the various time zones, the viewer could check the time in another zone and the device would then automatically reposition itself such that the front display would display the correct time in the viewer's zone.

Through the incorporation of an eccentric weighting system and freely rotating pivots on the rotational supports, the invention permits rotation of the device whereby upon the viewer's release of their grip on the device, the eccentrically weighted portion of the housing will always fall to the lowest position, to determine the relative position and orientation of the displays, due to gravitational action. The invention is contemplated to include a number of graphical or numerical display surfaces, oriented about the outer circumference of the device at various angles with respect to the eccentric weight. In order to position the preferred display face, as an example, in the front of the device, the viewer simply selects that display position which is roughly 90 degrees clockwise (or counterclockwise) from the eccentric weight.

In a preferred embodiment, the display device would be elongated and typically be encapsulated within an housing having an oblong or generally cylindrical shape with a pivot point located at each end of the housing. The cross section of the display device housing could be circular, or any other geometric shape which would allow for the arrangement of two or more display faces about its outer surface. For example, a triangular, square, hexagonal or octagonal cross section would work well for a device having 3, 4, 6 or 8 display faces, respectively. The invention would be oriented horizontally, with an axis of rotation as defined by the centerline between the two pivots. Each of the pivots would be supported by a stand having upwardly extending legs to attach to the display device to each pivot.

The invention would include an eccentric ballast weight in a fixed predetermined location inside the housing, which would necessarily cause the quadrant in which it is located to seek the lowest point of housing rotation, due to gravity. In a preferred embodiment of the invention, the ballast weight would be mounted in a track mechanism which would allow the user to reposition the weight in one of numerous predetermined positions, thereby permitting the user to change the favorite display face by simply repositioning the weight, rather than by changing or reprogramming each face display. In another embodiment, the power source which is used to energize the display sources could be a battery having sufficient size and shape that it could also function as the eccentric weight. As the battery would be a necessary component of that embodiment, its dual purpose use as both power supply and eccentric weight would conserve space and may prove economical for the manufacturer of the device.

In the preferred embodiment, one of the displays would be a clock display of time. Other displays could also be time, such that a user could program the displays for various time zones. In addition, calendar, weather, countdown timers or other features may occupy the other displays.

### BRIEF DESCRIPTION OF THE DRAWINGS

FIG. 1 is a top perspective view of the self righting device showing a preferred embodiment as it would typically be mounted to its stand.

FIG. 2 is a front elevation view of the preferred embodiment of the self righting device, showing the favorite display facing forward, or toward the viewer.

FIG. 3 is an end view of the self righting device, showing the pivot points about which the housing and displays may be rotated with respect to the stand.

FIG. 4 is a top view of a preferred embodiment of the self righting device which shows the upward facing position of a display which is located at 180 degrees with respect to the eccentric weight.

FIG. 5 is a back view a preferred embodiment of the self righting device which shows buttons that may be included to permit the user to program or calibrate one or more of the device's displays.

FIG. 6 is a bottom plan view of a preferred embodiment of the self righting device which shows the base portion of the stand upon which the device would rest and about which it would rotate.

FIG. 7 is a cross sectional view of a preferred embodiment of the self righting device which shows the position of the eccentric weight located in the lower quadrant of the housing. In this preferred embodiment, the power supply is a set of batteries, which also serves as the eccentric weight.

FIG. 8 is a view of the end of a preferred embodiment of the self righting device, in which the end cap is removed to show the bearing mechanism which is used to reduce the friction of rotation so as to ensure the eccentric weight quadrant of the housing falls freely to result in the desired orientation of the device at rest.

### DETAILED DESCRIPTION OF THE INVENTION

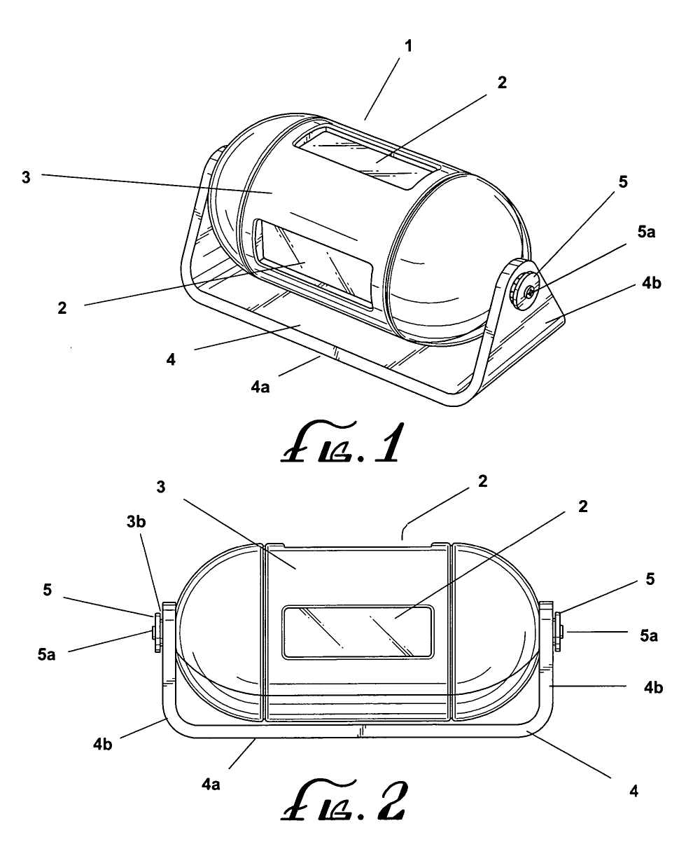

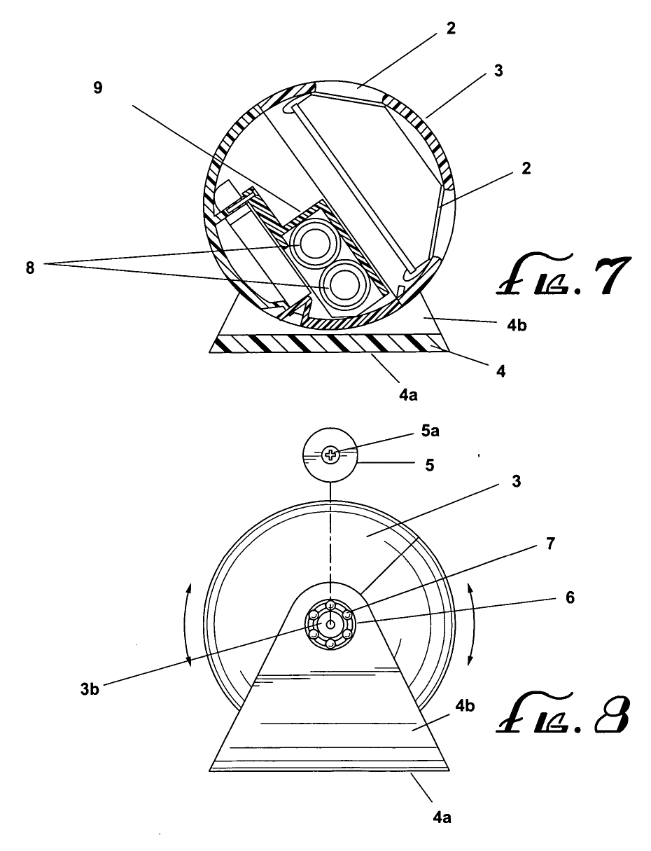

As seen in FIGS. 1 and 2, a preferred embodiment of the self righting device 1, comprises two or more displays 2, which are contained within an housing 3, that is supported by a stand 4. In the preferred embodiment of the self righting device 1 shown in the drawings, the housing 3 is depicted as having a circular cross section (see also FIG. 7). While a circular cross section works well, the housing 3 could be any cross section wherein two or more displays 2 could be located about its outer surface. For example, a triangular, square, hexagonal or octagonal cross section would work well for a device having 3, 4, 6 or 8 display faces, respectively.

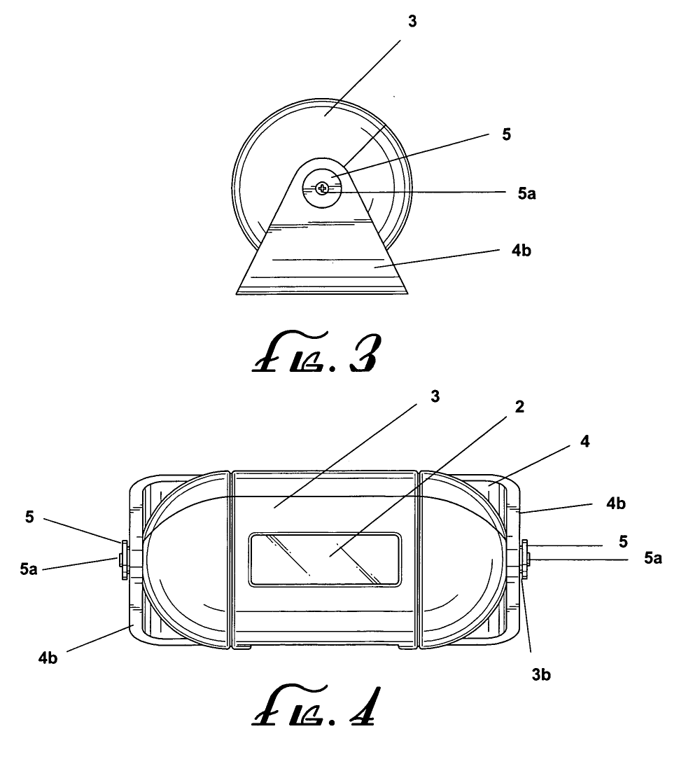

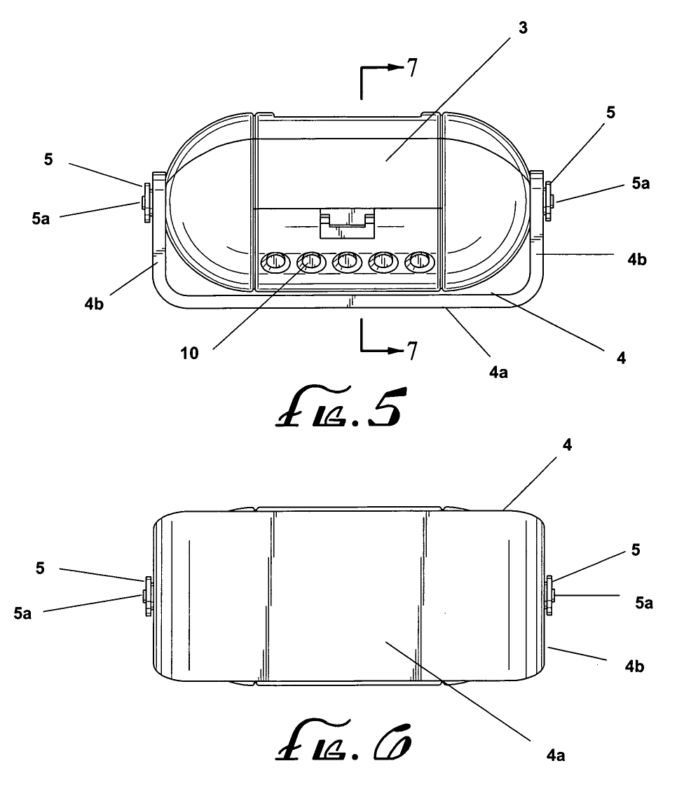

The stand 4 includes a base portion 4a, which is generally flat in this preferred embodiment as seen in FIG. 6, but which could also incorporate suction cups, mounting holes, or some secondary structure, such as a box for storing paper clips or notepads. The two ends of the stand 4 project upwardly to form legs 4b, which support the pivot points of the housing to permit free rotation. FIG. 3 shows the legs 4b of the stand 4, with each leg further including an end cap 5, and end screw 5a, which is inserted into and thereby secures the housing pivots 3b of the housing 3 to the legs 4b of the stand 4.

As shown in FIG. 8, in the preferred embodiment, the legs 4b include a circular bore 6, which is coaxial to the axis of rotation. The housing pivots 3b, in the preferred embodiment, are shown as extensions or trunnion ends of the housing 3 which would be inserted into the circular bores 6 of the legs 4b of the stand 4. A bearing 7, of the type well known to those skilled in the art is further included in the preferred embodiment, located in each cylindrical bore 6 and into which each of the housing pivots 3b is inserted to support the housing 3, as seen in FIG. 8. While the bearing 7 is depicted as a fully assembled and unitized style in the preferred embodiment, the antifriction function of the bearing may be accomplished by a structure in which bearing balls are inserted into the circular bore 6 and the pivot trunnion rides directly upon the balls. In other embodiments of the invention, the bearing function may be accomplished by simply rotating the housing pivots 3b upon the circular bore 6 of the stand legs 4b. If no separate antifriction bearing is used, the cylindrical bores 6 would be of an inside diameter such that a small amount of clearance would result when the housing pivots 3b are inserted into the cylindrical bores 6.

As shown in FIG. 4, the legs 4b and housing pivots 3b define the centerline of an axis of rotation such that the housing 3 may rotate about said axis, with respect to the stationary stand 4. In the preferred embodiment, the housing 3 and its axis of rotation are horizontal. While the horizontal axis of rotation works well, the housing 3 and axis of rotation could be inclined from horizontal at some angle as long as the eccentric can be positioned such that one quadrant of the housing 3 would fall freely to the lowest point of rotation due to gravity. In FIG. 4, one of the displays 2 is shown to be oriented facing upward when the housing 3 is at rest.

The self righting feature of the device 1 is accomplished through the use of an eccentric weight located in one inner quadrant of the housing 3. The weight is positioned eccentrically with respect to the axial centerline of the housing 3. At rest, or subsequent to partial or full rotation of the housing 3, gravity will act upon the eccentric weight and will cause the portion of the housing in which the weight is located to come to rest at the lowest point of rotation. Knowing the eccentric weighted portion of the housing will be so located at rest, a display located at 90 degrees from the weight with respect to the horizontal centerline of the housing 3, will thereupon be facing outward from the front (or rear) side face of the housing, such as depicted in FIG. 2. The manufacturer or user of the invention may thereby select a favorite display based on the relative position of the eccentric weight and displays.

FIG. 7 shows a cross sectional view of the housing 3 of a preferred embodiment, in which the power supply is a pair of cylindrical batteries 8. These batteries 8 are of sufficient size and weight that when inserted into the battery case 9, they function as the eccentric weight for the invention. In alternate embodiments of the invention, the eccentric weight could be an entirely separate component from the batteries 8. This would be the case, for example, if the batteries were much smaller and therefore, of insufficient weight to achieve the eccentric weight self righting function. Although FIG. 7 shows the batteries 8 and battery case 9 rigidly mounted inside the housing 3, alternate mounting mechanisms are contemplated to be within the scope of the invention. In alternate embodiments of the invention, the eccentric weight, or the batteries, if they so incorporated the eccentric weight function, could be mounted on a moveable track such that the weight could be repositioned to a predetermined locations within the housing 3, corresponding to a specific display as the favorite, or thereby designated front facing display. By repositioning the weight in this manner, the user could select an alternate display as the favorite side, to be facing forward or upward when the housing is at rest.

In a preferred embodiment, the housing 3 further includes a number of buttons 10 for mode and/or function selection. By sequentially pressing the various buttons 10, the user may program, initiate or calibrate each of the displays 2 of the invention.

The outer surfaces of the housing 3, stand 4 and legs 4b, having relatively smooth surfaces, are also well-suited for application of art work, logos and graphics for advertising and promotional purposes.

What is claimed is:

1. A self righting device comprised of:
(a) two or more sources for generating numerical or graphical information;
(b) two or more displays located on different surfaces of the device for conveying said information to a viewer;
(c) a display housing for retaining the sources and displays;
(d) a stand to support the display housing;
(e) a rotating means permitting rotational motion of the display housing with respect to the stand; and,
(f) a self-righting means, located within the display housing and urging the display to return to its original orientation following partial or full rotation of the display housing with respect to the stand.

2. The self-righting device of claim 1, wherein the rotating means includes a connecting means whereby the housing is rotationally connected to the stand.

3. The self-righting device of claim 1 wherein the self righting means includes a weight asymmetrically disposed with respect to the axis of rotation.

4. The self-righting device of claim 2, wherein the connecting means is comprised of two pivotable connections whereby the display housing may rotate with respect to an axis defined by the centerline between the connections.

5. The self-righting device of claim 4, wherein the connecting means further includes bearings upon which the display housing is supported at the pivotable connections.

6. The self-righting device of claim 4, wherein at least one source includes a clock for generating the time or elapse time.

7. The self-righting device of claim 4, wherein at least one source includes a calendar mode function for generating the date.

8. The self-righting device of claim 4, wherein the display housing further includes a lens for magnifying the graphical information of a display.

9. The self-righting device of claim 8, wherein the external surface of the display housing and lens form a substantially oblong shape.

10. The self-righting device of claim 8, wherein the device further includes an attaching means for attaching the stand to an object.

10. The self-righting device of claim 10, wherein the attaching means is comprises one or more suction cups.

12. The self-righting device of claim 10, wherein the attaching means further includes one of the group consisting of: clips, adhesive, and screws.

13. The self-righting device of claim 1, wherein the device further includes one or more input devices for setting and altering the graphical information of at least one display.

14. The self-righting device of claim 1, where wherein at least one display includes a liquid crystal display.

15. The self-righting device of claim 1, wherein at least one display includes one ore more light emitting diodes.

16. The self-righting device of claim 1, further including printed or graphical imprinting on its surface for the purpose of advertising or promotion.

17. A self-righting device comprising:
(a) at least two information sources, comprising a clock and at least one other type of source;
(b) a display for each source located on different surfaces of the device including a display for displaying time;
(c) a display housing;
(d) a stand to provide support for the display housing;
(e) a self-righting means, operatively coupled with the display housing, and further comprising:
(i) an assembly including at least two pivot points, characterizing an axis of rotation, for supporting relative rotational motion of the display and display housing; and
(ii) a weight asymmetrically disposed with respect to the axis of rotation for urging the display to return to its original orientation following partial or full rotation of the display housing with respect to the stand; and
(f) two connecting means, operatively coupling the display housing and stand, including two pivotable connections including bearings, characterized by an axis of rotation, for supporting rotational motion of the display housing.

18. The self-righting device of claim 17, further including printed or graphical imprinting on at least one outer surface for the purpose of advertising or promotion.

19. A method of advertising or promotion comprising the imprinting of printed or graphical material on a surface of a self righting device which has:
two or more sources for generating numerical or graphical information; two or more displays located on different surfaces of the device for conveying said information to a viewer; a display housing for retaining the sources and displays; a stand to support the display housing; a rotating means permitting rotational motion of the display housing with respect to the stand; and a self-righting means, located within the display housing and urging the display to return to its original orientation following partial or full rotation of the display housing with respect to the stand.
